(19) United States
(12) Patent Application Publication
(10) Pub. No.: US 2003/0074366 A1
(43) Pub. Date: Apr. 17, 2003

(54) List display data generating apparatus and a program thereof

(75) Inventors: Toshiro Shibanuma, Kawasaki (JP); Masaaki Daimon, Kawasaki (JP); Hisayasu Nakao, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/084,468

(22) Filed: Feb. 28, 2002

(30) Foreign Application Priority Data
Oct. 12, 2001 (JP) 2001-315000

(51) Int. Cl. G06F 7/00

(52) U.S. Cl. 707/102

(57) ABSTRACT

The display attribute of data essential for structuring list display data is varied according to the degree of newness of information, so that a user can easily verify the newest information. On a list display data generating apparatus of this invention, the display attribute, for example, the color, the background, the style, etc. of characters, or the like, which is essential for a listing display such as the registration date and time of information, etc., can be varied on a display screen of an information listing. Accordingly, the degree of newness of information can be displayed without displaying, for example, a special image representing the number of elapsed days, and without reducing the amount of information displayed on one screen. Consequently, a user can quickly grasp the registered contents of information to be browsed without overlooking the information.

### BACKGROUND OF THE INVENTION

1. Field of the Invention

The present invention relates to a system generating list display data of a plurality of pieces of information, and more particularly, to an apparatus or a program generating list display data of a plurality of pieces of information such as an article posted to an electronic bulletin board, an electronic conference room, etc., a document registered to a document management database, and the like, in correspondence with these pieces of information, thereof.

2. Description of the Related Art

With the recent advances of network technology, functions of an electronic bulletin board, an electronic conference room, etc. have been realized as one system of groupware on a LAN or the Internet. Each user who forms a group can freely register information (an article), for example, to such an electronic bulletin board.

FIG. 1 exemplifies a display screen on which the subjects of information, the names of registrants, registration dates and times, etc. are listed and displayed on the same page in correspondence with the information posted to such a conventional electronic bulletin board, electronic conference room, document management (database), etc.

Such a list display screen is implemented as one function of groupware. In FIG. 1, subjects (article or document names), names of registrants (persons who post an article or document), and registration dates and times (dates and times of posting) are displayed as the listing data of a plurality of pieces of earlier than one weekly arrived registration information in the respective display areas of the electronic bulletin board, the electronic conference room, and the document management.

As shown in FIG. 1, if listing data corresponding to many pieces of information are displayed on one page, for example, the color, the style, the background color, etc. of displayed characters are the same regardless of whether an article is either old or new. This is because the display attributes of the listing data are unified.

Normally, these pieces of listing data are sorted and displayed in an order of information registration dates. However, if there is no newly registered article, the initial article is not necessarily be an article having the current date although the data are sorted in an order of newer arrivals (order of registration dates).

Accordingly, it is difficult to find a really new article, that is, an article having the newest date, partly because the display attributes are uniformed as described above. Therefore, contents of a newly arrived article are overlooked, or the contents of the same article are repeatedly viewed.

For the verification of information among such many pieces of information, namely, a display of a link node (linked document) that newly appears in document management using groupware or a hypermedia system, the following conventional techniques exist.

Document 1) Japanese Patent Publication No. 10-228469 Information Processing Device and Controlling Method Thereof

Document 2) Japanese Patent Publication No. 10-283365 Document Display Device and Program Storage Medium

Document 3) Japanese Patent Publication No. 6-251082 Hypermedia System

Document 1) discloses a technique for displaying document data in a way such that the older the date of a document, the more the right portion of the document is hidden, for example, if reduced images of a plurality of documents are displayed on one screen, or a technique for cascading reduced image data of documents by using the registration or update date of a document as an axis of the direction of the depth.

Document 2) discloses a technique applicable to groupware, with which document contents, and date information written in the document contents are extracted, and the number of documents the contents of which are associated are extracted in a time unit, namely, the appearance frequency of documents, the contents of which are associated, is obtained. This technique reveals, for example, the fact that articles on food poisoning appear most frequently in the summer as a result of aggregating the date information of articles including a character string “food poisoning” for each month.

Document 3) discloses a technique that targets a document of hypermedia having a network structure in which a plurality of nodes having data of arbitrary media are linked, and highlights the appearance of a linked node by changing part of a displayed portion with the use of an enclosure display using a rectangle, a color display, a blinking display, etc. when a new liked node dynamically appears.

However, the technique disclosed by Document 1) requires extra processes other than an originally required data display, such as a process for hiding the right portion of reduced image data, or a process for cascading reduced images in the direction of the depth, for example, in correspondence with registration dates and times. At the same time, the amount of information that can be displayed on screen becomes small due to the widening of display space. Therefore, a user cannot obtain a large amount of information at one time.

Document 2) is intended to reveal the association between the appearance frequency of documents and their contents by extracting date information from the contents of the documents. Therefore, this cannot accomplish the object of making the degree of newness of information clear, which is targeted by the present invention.

Document 3) only facilitates the verification of a new linked node that dynamically appears, and has, for example, a problem that the degree of oldness of certain information cannot be clearly displayed.

### SUMMARY OF THE INVENTION

The present invention was developed in the above described background, and aims at making it easier that a user verifies new information.

A list display data generating apparatus and a program thereof according to the present invention make it easier that a user verifies new information by changing a display attribute of data essential for structuring list display data, for example, a display attribute such as a display color or a display style of characters that represent date and time of each of a plurality of pieces of information, according to the degree of newness of information, when generating the list display data corresponding to the plurality of pieces of information.

As described above, the display attribute of characters essential for a listing display, such as the registration date and time of information, etc. are changed on a display screen of information listing, so that the degree of newness of information can be displayed without displaying, for instance, a special image which represents the number of elapsed days, and without reducing the amount of information displayed on one screen. Consequently, a user can quickly grasp the registered contents of information to be browsed without overlooking the information. This greatly contributes to an improvement in the practicality of an information list display apparatus.

### BRIEF DESCRIPTION OF THE DRAWINGS

FIG. 1 exemplifies a conventional display screen on which information registered to an electronic bulletin board, an electronic conference room, etc. are listed;

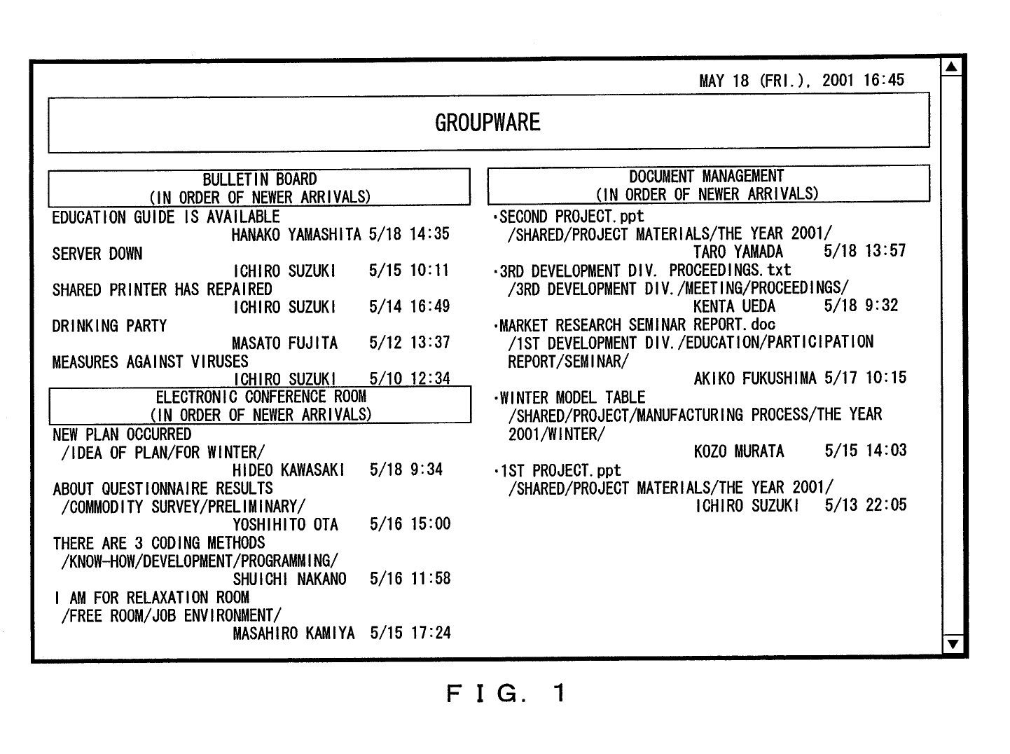

FIG. 2 is a block diagram showing the configuration of a first preferred embodiment according to the present invention;

FIG. 3 is a block diagram showing the configuration of an entire system according to a second preferred embodiment of the present invention;

FIG. 4 is a flowchart showing the process for displaying a screen in the second preferred embodiment;

FIG. 5 exemplifies the contents stored in a bulletin board database;

FIG. 6 shows a first example of contents stored in a display attribute information table;

FIG. 7 exemplifies a screen display corresponding to the display attribute information table shown in FIG. 6;

FIG. 8 shows a second example of contents stored in the display attribute information table;

FIG. 9 exemplifies a screen display corresponding to the display attribute information table shown in FIG. 8;

FIG. 10 shows a third example of contents stored in the display attribute information table;

FIG. 11 exemplifies a screen display corresponding to the display attribute information table shown in FIG. 10;

FIG. 12 shows a fourth example of contents stored in the display attribute information table;

FIG. 13 exemplifies a screen display corresponding to the display attribute information table shown in FIG. 12; and

FIG. 14 explains the loading of a program for implementing the present invention into a computer.

### DESCRIPTION OF THE PREFERRED EMBODIMENTS

First Preferred Embodiment

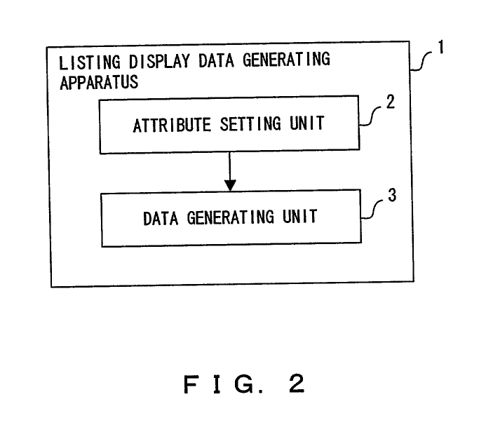

FIG. 2 is a block diagram showing the configuration of a first preferred embodiment according to the present invention. This figure shows the principle of the configuration of a list display data generating apparatus generating list display data of a plurality of pieces of information.

In FIG. 2, a list display data generating apparatus 1 is, for example, a Web server, and comprises an attribute setting unit 2 and a data generating unit 3.

The attribute setting unit 2 sets a display attribute such as the display color of the registration date and time of list display data, the style of displayed characters, or the like for each of a plurality of pieces of information based on the relationship between the date of date and time information of each of the plurality of pieces of information, for example, the registration date of information, and the current date.

The data generating unit 3 generates list display data of a plurality of pieces of information by using the attribute set by the attribute setting unit 2, and generates, for example, display data of the above described registration date and time so that the color or the size of displayed characters of the registration date and time match preset color and size.

In this preferred embodiment, the attribute setting unit 2 can set a display attribute of certain information having date and time information the date of which is the current date as a display attribute different from that of information having date and time information the date of which is the preceding day or earlier, or can set a display attribute of a plurality of pieces of information according to the number of days elapsed from the date of date and time information to the current date.

Furthermore, in this preferred embodiment, the list display data generating apparatus 1 may further comprise a data transmitting unit externally transmitting list display data that is generated by the data generating unit 3 so as to make an external device display the list display data. For example, list display data is transmitted from a Web server to a client terminal, whereby the list display data is displayed on the client terminal side.

Additionally, a list display data generating method according to the present invention is a method with which a display attribute is set for each of a plurality of pieces of information based on the relationship between the date of date and time information of each of the plurality of pieces of information and the current date, and list display data of the plurality of pieces of information is generated by using the set display attribute.

A storage medium according to the present invention is a computer-readable portable storage medium on which is recorded a program for causing a computer to execute a process which comprises: setting a display attribute for each of a plurality of pieces of information based on the relationship between the date of date and time information of each of the plurality of pieces of information and the current date; and generating list display data of the plurality of pieces of information by using the set display attribute.

Furthermore, a program according to the present invention is a program for causing a computer to execute a process which comprises: setting a display attribute for each of a plurality of pieces of information based on the relationship between the date of date and time information of each of the plurality of pieces of information and the current date; and generating list display data of the plurality of pieces of information by using the set display attribute.

In this preferred embodiment, the display attribute of certain information having date and time information whose date is the current date can be also set as a display attribute different from that of information having date and time information whose date is the preceding day or earlier, or the display attribute of a plurality of pieces of information can be set according to the number of days elapsed from the date of date and time information to the current date, in the operations for setting a display attribute.

Furthermore, in this preferred embodiment, the process in the above described program may further comprise externally transmitting generated list display data so as to make an external device display the list display data.

As described above, according to the present invention, the display attribute of list display data is set, for example, based on the relationship between the registration date and time of registered information and the current date.

As a result, according to the present invention, a display attribute of characters essential for a listing display, such as the registration date and time of information, etc., is changed, so that the degree of newness of information can be displayed without displaying, for example, a special image, etc., which represents the number of elapsed days, and without reducing the amount of information displayed on screen. In this way, a user can quickly grasp the registered contents of information to be browsed without overlooking the information. This greatly contributes to an improvement in the practicality of an information list display device.

Second Preferred Embodiment

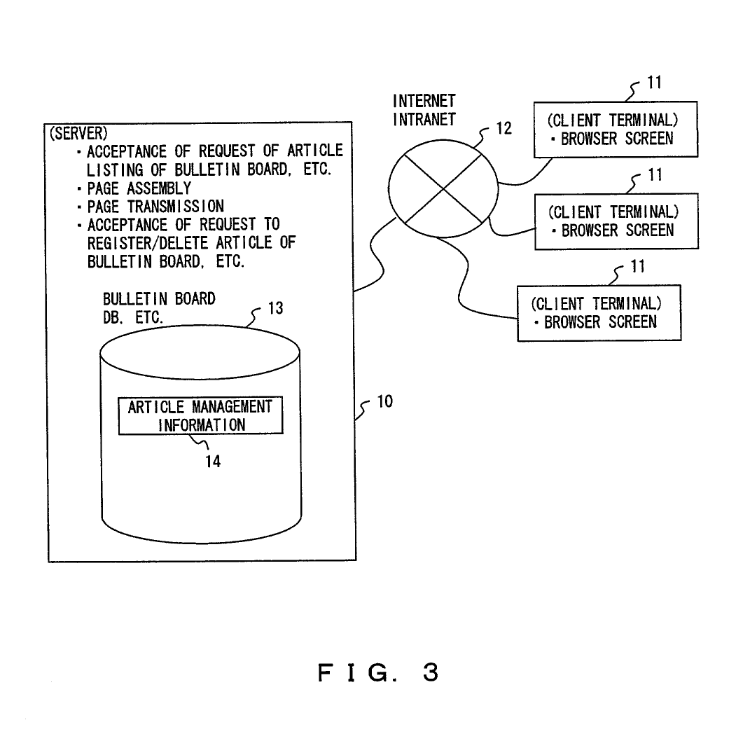

FIG. 3 is a block diagram showing the configuration of a server-client system according to the second preferred embodiment of the present invention. In this figure, the system is configured by a server 10, a plurality of client terminals 11, and a network 12 such as the Internet or an intranet, which interconnects the server 10 and the client terminals 11. The server 10 is, for example, a Web server that implements a groupware function. The client terminals 11 are, for example, personal computers that are used by respective members forming a group.

The server 10 comprises a bulletin board database (DB), etc. 13, namely, various types of databases such as a member information database for implementing groupware, an electronic conference room database, a schedule database, etc.

These databases store, for example, article management information 14 corresponding to the contents of the bulletin board database, a display attribute information table for defining the correspondence between date information and a display attribute, which is intended to implement the present invention, and the like.

The server 10 comprises a groupware program having the function for executing a process according to this preferred embodiment in addition to a program for implementing the function of a normal Web server. This program is intended to execute operations such as acceptance of a request of an article listing of a bulletin board, etc., page assembly, page transmission, acceptance of a request to register/delete an article of a bulletin board, etc.

In each of the client terminals 11, a Web browser is installed, and information is exchanged between the Web browser and the Web server based on HTTP (Hypertext Transfer Protocol). A user can browse and register the information managed by the groupware by using the Web browser.

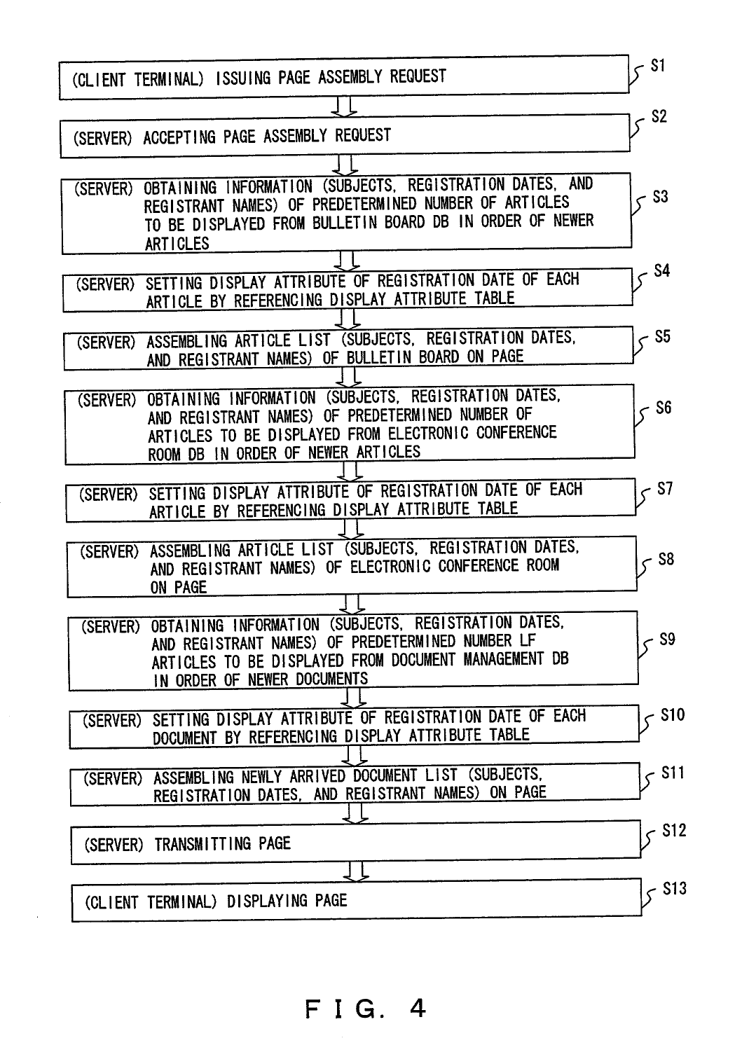

FIG. 4 is a flowchart showing a screen display process in this preferred embodiment. In this figure, the client terminal 11 side first issues a page assembly request to the server 10. This corresponds to an operation of requesting the server to display a list display screen such as a bulletin board, etc. after a user ID and a password, which are input on the initial screen for inputting a user ID and a password, are authenticated, for example, in a groupware system.

This also corresponds to an operation of requesting a redisplay of a screen that includes newly registered information, for example, by clicking a redisplay button on the list display screen that is already made visible.

The server 10 accepts the request issued from the client terminal 11 in step S2. In step S3, the server 11 obtains information of a predetermined number of articles to be displayed, namely, subjects of articles, registration dates and times, and registrant names are obtained from the bulletin board DB in order of newer articles. Then, the server 10 references a display attribute table to be described later, and sets the display attribute of registration date and time of each of the articles in step S4. In step S5, the server 10 generates a bulletin board article list as display screen data on a page, namely, a listing of subjects, registration dates, and registrant names.

In this preferred embodiment, the bulletin board DB stores, for example, a subject, registration date and time, a registrant name, registered contents, etc. for each piece of information. In step S3, the subject, the registration date and time, and the registrant name among them are obtained, and the obtained information are sorted, for example, in order of newer articles. In step S4, the number of days elapsed from the registration date of each information is calculated by using the current date. If the bulletin board DB (and other DBs to be described later) already stores information in order of registration dates, this sorting process is unnecessary, and information may be merely obtained in order of newer articles.

Then, the display attribute of registration date is set according to the number of elapsed days based on the date information, and the contents of the display attribute table composed of display attribute information of characters that correspond to the date information. In step S5, a bulletin board article list is assembled in step S5.

Next, the server 10 performs operations similar to those of steps S3 to S5 by targeting articles of the electronic conference room in steps S6 to S8. Namely, in step S6, subjects of articles, registration dates, and registrant names are obtained from the electronic conference room DB in order of newer registration dates as information of a predetermined number of articles to be displayed. In step S7, the display attribute of registration date of each of the articles is set by referencing the display attribute table. In step S8, an electronic conference room article list on the page, namely, a list of the subjects, the registration dates, and the registrant names is assembled.

Then, in steps S9 to S11, operations similar to those of steps S3 to S5 are performed by targeting the contents registered to the document management DB. Firstly, in step S9, subjects (document names), registration dates, and registrant names are obtained from the document management DB in order of newer dates as information of a predetermined number of documents to be displayed. In step S10, the display attribute of the registration date of each of the documents is set by referencing the display attribute table in step S10. In step S11, a list of newly arrived documents on the page, namely a list of the subjects, the registration dates, and the registrant names is assembled.

With the above described process, the assembly of the page to be displayed on the client terminal 11 side is terminated. In step S12, the page is transmitted from the server 10 to the client terminal 11 that has issued the page assembly request. In step S13, the page is displayed on the client terminal 11 side.

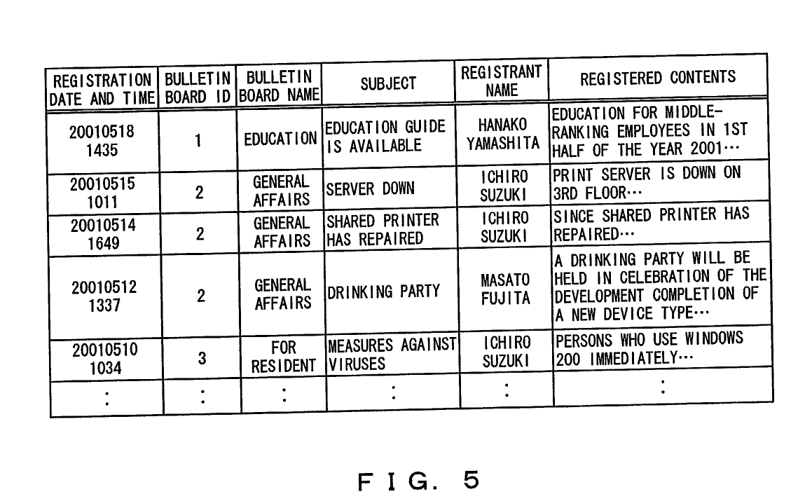

FIG. 5 exemplifies the contents stored in the bulletin board DB shown in FIG. 3. The contents include, for each piece of information, an ID and a bulletin board name if there are bulletin board types in addition to registration date and time, a subject, a registrant name, and registered contents.

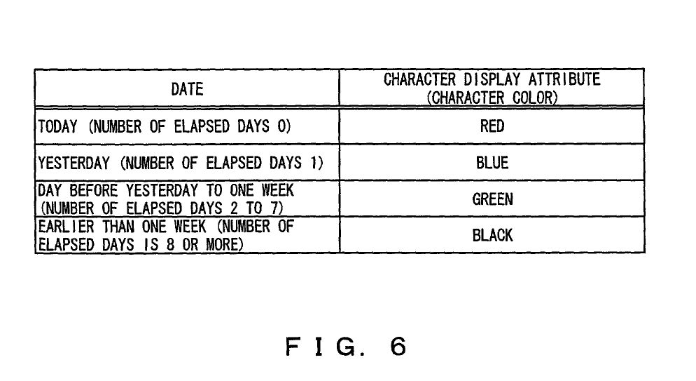

FIG. 6 shows a first example of contents stored in the display attribute information table. In this preferred embodiment, it is assumed that the display attribute of characters (numbers) representing the registration date and time of each piece of information is varied according to the number of days elapsed from information registration.

In FIG. 6, the number of elapsed days until the current date, namely, today, is obtained based on the registration date of each of the plurality of pieces of information, and the display color of characters that represent the registration date and time on the display screen is varied according to the number of elapsed days. Namely, in the example shown in FIG. 6, the display attribute of characters (the color of characters in this case) is red if the registration date is today (the number of elapsed days is 0), the color of characters is blue if the registration date is yesterday (the number of elapsed days is 1) , the color of characters is green if the registration date is the day before yesterday to one week (the number of elapsed days is 2 to 7), and the color of characters is black if the registration date is earlier than one week (the number of elapsed days is 8 or more).

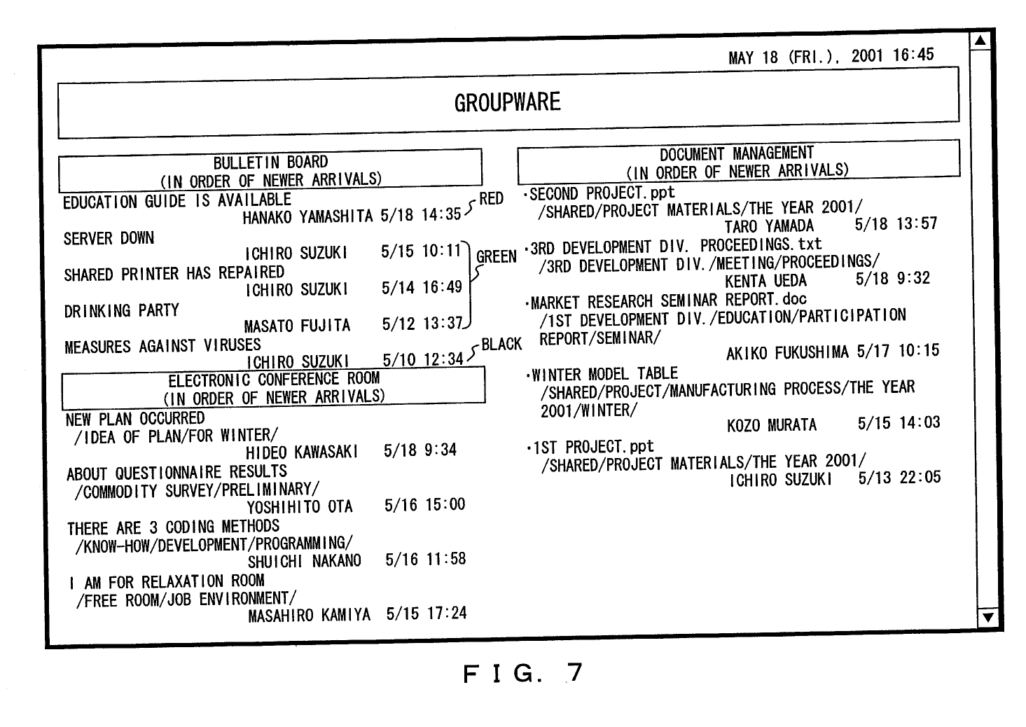

FIG. 7 exemplifies a screen display when the display attribute information table shown in FIG. 6 is used. Here, the current date is May 18th. For example, the registration date and time of information of the record in the first line is the current date “20020518 1435” among the information of the bulletin board shown in FIG. 6. Therefore, the registration date and time is displayed as “5/18 14:35” in red in FIG. 7.

Additionally, the registration dates and times of the information of the records in the 2nd to the 4th lines in FIG. 6 are “20010515 1011”, “20010514 1649”, and “20010512 1337”, and correspond to the case of the day before yesterday to one week (the number of elapsed days is 2 to 7). Therefore, all of the registration dates and times are respectively displayed as “5/15 10:11”, “5/14 16:49”, and “5/12 13:37” in green in FIG. 7.

Furthermore, the registration date and time of the information of the record in the last line in FIG. 6 is “20010510 1034”, and corresponds to the case of earlier than one week (the number of elapsed days is 8 or more) . Therefore, this registration date and time is displayed as “5/10 12:34” in black in FIG. 7.

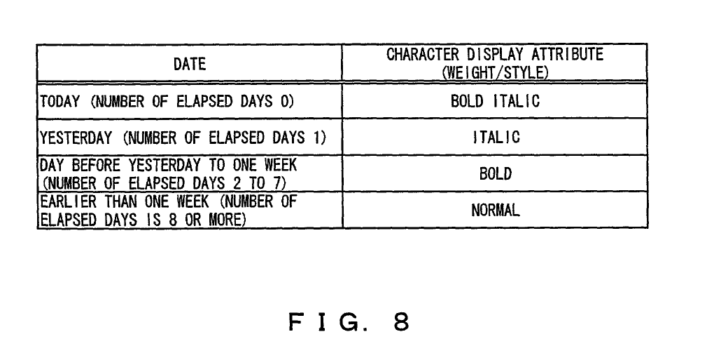

FIG. 8 shows a second example of contents stored in the display attribute information table. This is an example where a weight/style as the display attribute of characters is varied in correspondence with the number of days elapsed from the registration date of each piece of information. In the example shown in FIG. 8, the weight of characters is bold and the style is italic if the registration date is the current day (the number of elapsed days is 0), the style of characters is italic if the registration date is yesterday (the number of elapsed days is 1), the weight of characters is bold if the registration date is the day before yesterday to one week (the number of elapsed days is 2 to 7), and both the weight and the style of characters are normal if the registration date is earlier than one week (the number of elapsed days is 8 or more).

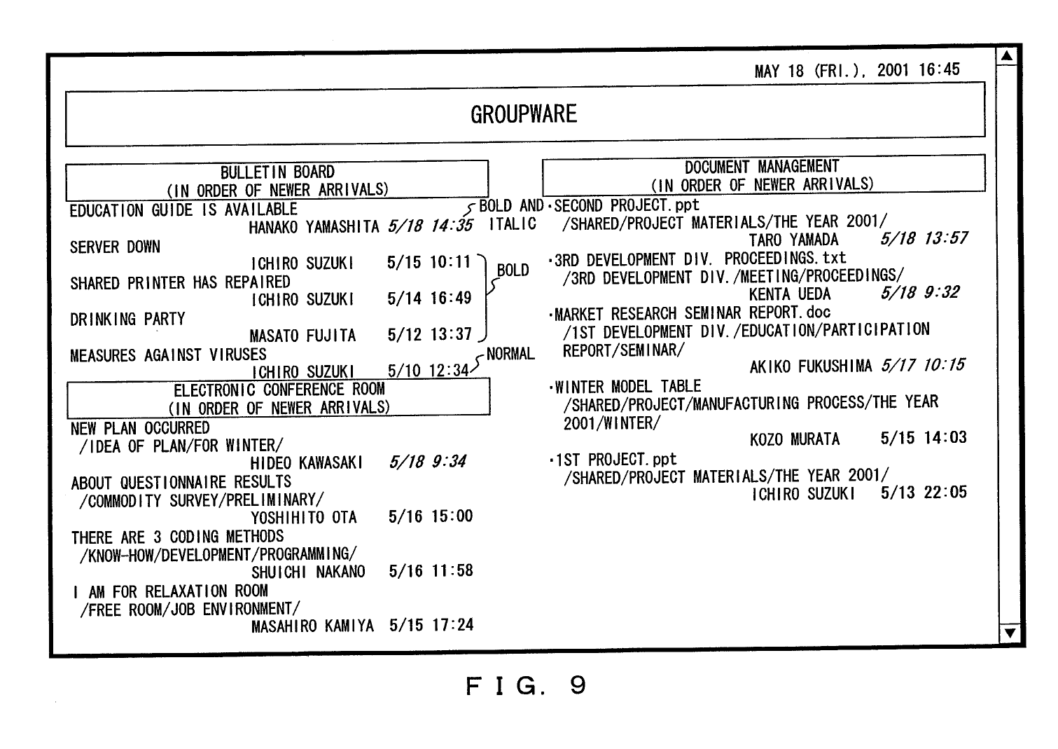

FIG. 9 exemplifies a screen display corresponding to the display attribute information table shown in FIG. 8. In this figure, for example, the registration date of the initial information (the record in the first line) among the information of the bulletin board shown in FIG. 7 is “today” as described above. Therefore the characters representing the date are bold and italic in FIG. 9 based on the display attribute information table shown in FIG. 8. Additionally, since the registration dates of the succeeding 3 pieces of information correspond to the case of “the day before yesterday to one week” as described above, their characters of the dates are bold in FIG. 9. Furthermore, the registration date of the last piece of information corresponds to the case of “earlier than one week”, the characters of this date are displayed as a normal typeface.

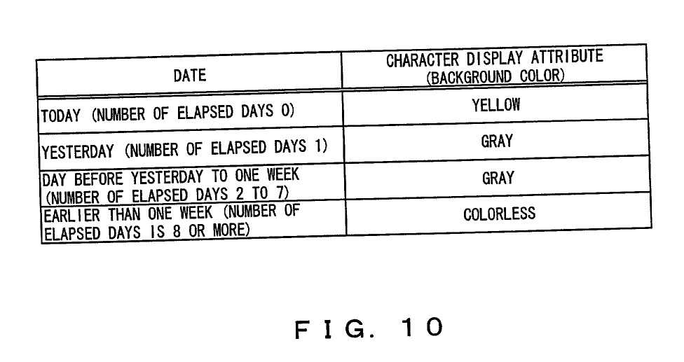

FIG. 10 shows a third example of contents stored in the display attribute information table. In this example, the background color as the display attribute of characters representing registration date and time are varied according to the number of days elapsed from the registration date of each piece of information. Namely, in the example shown in this figure, the display attribute (the background color in this case) of characters is yellow if the registration date is today (the number of elapsed days is 0), the background color of characters is gray if the registration date is yesterday (the number of elapsed days is 1), and the background color of characters is also gray if the registration date is the day before yesterday to one week (the number of elapsed days is 2 to 7), and the background color of characters is colorless if the registration date is earlier than one week (the number of elapsed days is 8 or more).

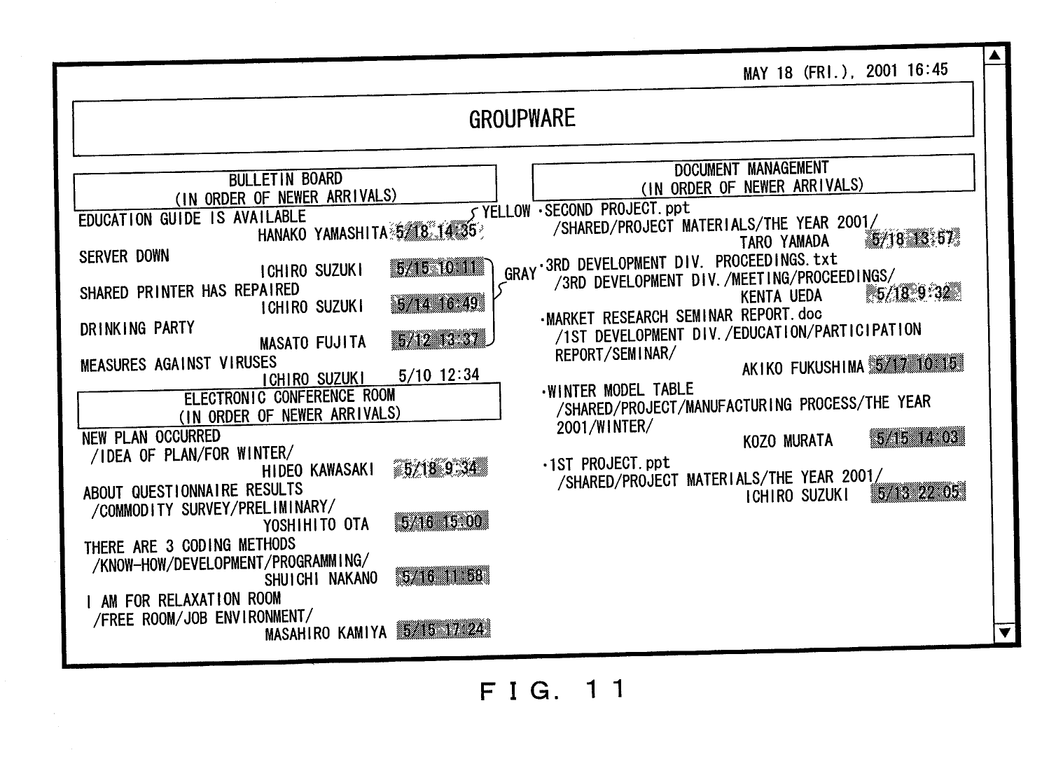

FIG. 11 exemplifies a screen display corresponding to the display attribute information table shown in FIG. 10. In this figure, for example, the registration date of the initial information is “today” among the information of the bulletin board. Therefore, the background color of characters representing this date is yellow. Additionally, the background color of the registration dates of the succeeding 3 pieces of information is gray in FIG. 11 since these pieces of information correspond to the case of “the day before yesterday to one week”. Furthermore, the background color of characters representing the registration date of the last information is colorless in FIG. 11, since this date corresponds to the case of “earlier than one week”.

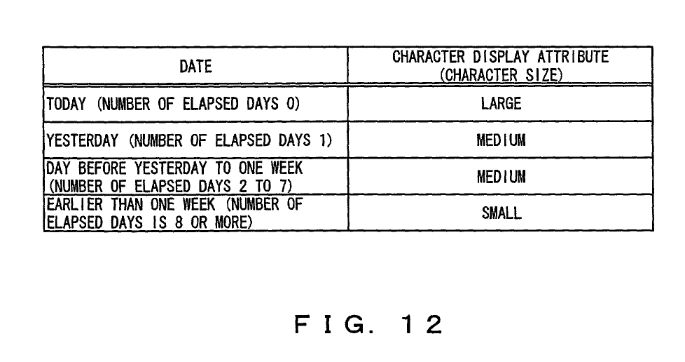

FIG. 12 shows a fourth example of contents stored in the display attribute information table. Here, the size of characters representing registration date and time is varied according to the number of days elapsed from the registration date of information. Namely, in the example shown in this figure, the display attribute (the size in this case) of characters is large if a registration date is today, the size of characters is medium if a registration date is yesterday, the size of character is also medium if a registration date is the day before yesterday to one week, and the size of characters is small if a registration date is earlier than one week.

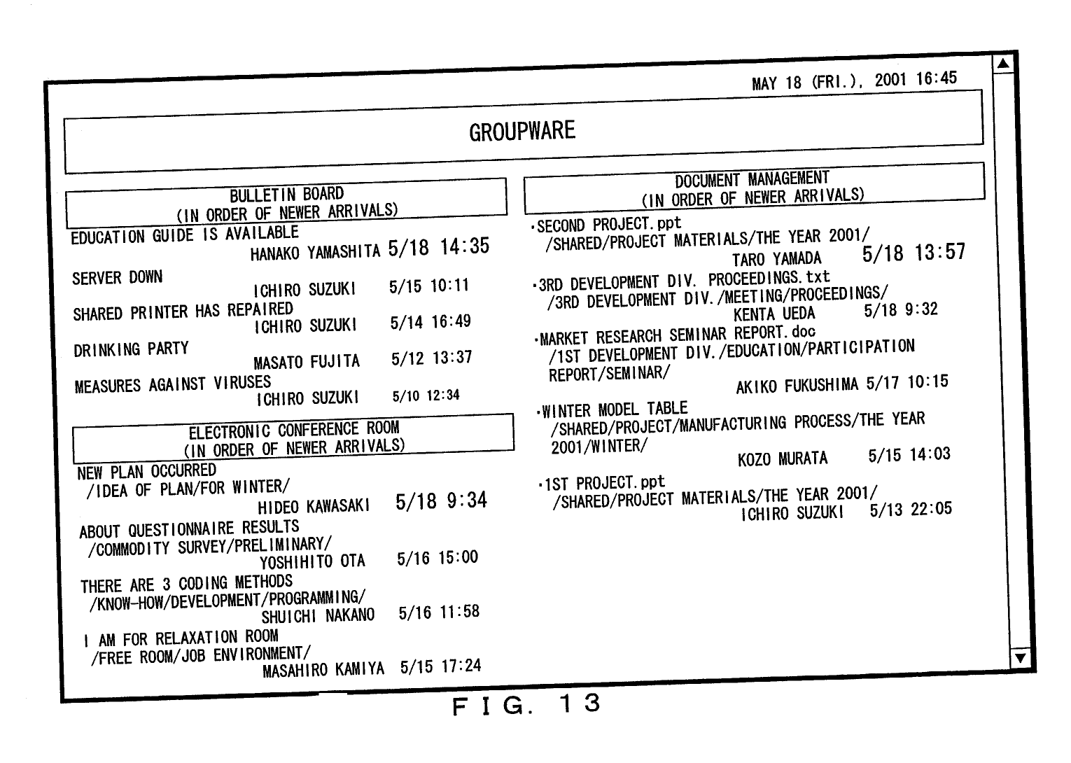

FIG. 13 exemplifies a screen display corresponding to the display attribute information table shown in FIG. 12. In this figure, for example, the registration date and time of the initial information among the 5 pieces of information of the bulletin board is “today”. Therefore, in FIG. 13, the characters representing this date are displayed in uppercase, characters representing the registration dates of the succeeding 3 pieces of information are “the day before yesterday to one week”. Therefore, in FIG. 13, the characters representing these days are displayed in middle case letter. And the registration date and time of the last information is “earlier than one week”. Therefore, in FIG. 13, the characters representing this date are displayed in lower case letter.

Note that the contents of the process for generating and displaying a list display screen are similar to those of the process which is earlier described with reference to FIG. 4, if any of the above described second to fourth display attribute information tables is used.

Additionally, the display attributes implemented in the present invention are not limited to the examples referred to in this specification. Any display attribute can be a setting target as long as it does not deviate from the scope of the present invention.

Up to this point, the list display data generating apparatus according to the present invention was described in detail. As a matter of course, this list display data generating apparatus can be configured as a general computer system.

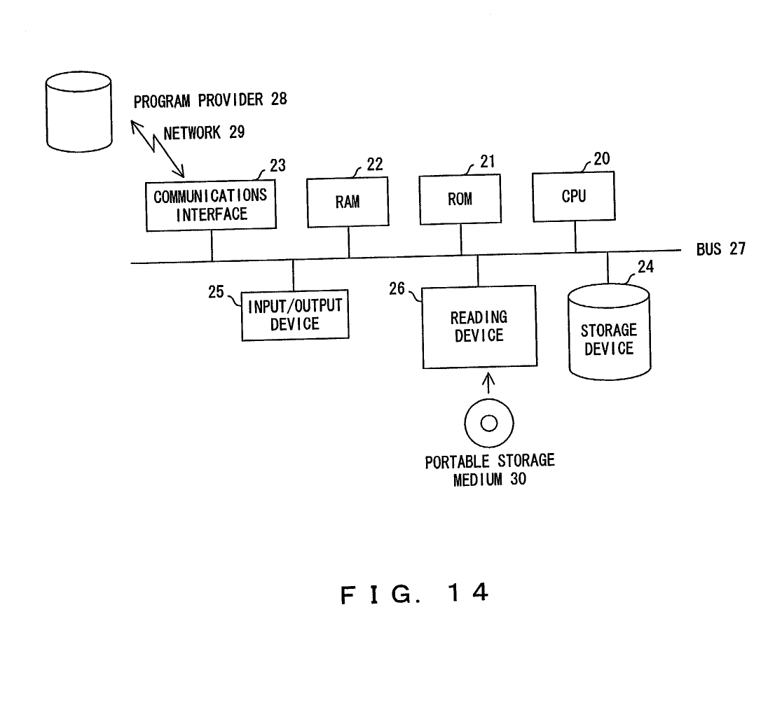

FIG. 14 is a block diagram showing the configuration of such a computer system, namely, hardware environment. In this figure, this computer system is configured by a CPU (Central Processing unit) 20, a ROM (Read-Only Memory), a RAM (Random Access Memory) 22, a communications interface 23, a storage device 24, an input/output device 25, and a reading device 26 of a portable storage medium, which are interconnected by a bus 27.

As the storage device 24, various forms of a storage device such as a hard disk, a magnetic disk, etc. can be used. The program on the server side, which is represented by the flowchart shown in FIG. 4, or the program recited in claim 5 of the present invention is stored in such a storage device 24 or ROM 21. Such a program is executed by the CPU 20, whereby the list display data generating apparatus according to the preferred embodiment of the present invention can be implemented.

Such a program may be stored, for example, in the storage device 24 from a program provider 28 side via a network 29 and the communications interface 23. Or, such a program may be stored onto a marketed and distributed portable storage medium 30, set in the reading device 27, and executed by the CPU 20. As the portable storage medium 30, various forms of a storage medium such as a CD-ROM, a floppy disk, an optical disc, a magneto-optical disc, etc. may be used. The program stored onto such a storage medium is read by the reading device 26, whereby the list display data generating apparatus according to the preferred embodiment of the present invention can be implemented.

The above provided explanation refers to a change in the display attribute of characters representing the registration date and time of each information, mainly on the information of a bulletin board. However, looking at FIG. 9 or FIG. 13, it is clear that the change in the display attribute of characters representing the registration date and time of each information may apply to an electronic conference room and also to a document management.

In the above described preferred embodiment, a display attribute is determined based on a date on which information is registered. However, a display attribute can be determined based on not only date, but also time or time information. The present invention also covers such preferred embodiments.

Additionally, for example, the display attribute of characters representing an information subject or a registrant name can be naturally varied according to the number of days elapsed from the registration of information instead of varying the display attribute of characters representing registration date and time.

Furthermore, the above provided explanation assumes that list display data is generated in a Web server, and displayed on a client terminal. However, the present invention is not limited to such an implementation. The present invention is applicable, for example, to the case where a listing of files within a memory is displayed in a computer that is not connected to a network, as a matter of course.

What is claimed is:

1. An apparatus generating list display data where contents extracted from registration information are sorted in an order of newer arrivals, comprising:
an attribute setting unit setting a display attribute of a list display target for contents of the list display target based on a relationship between a date on which the contents are registered and a current date; and
a data generating unit generating list display data of the contents of the list display target by using the set display attribute.

2. The list display data generating apparatus according to claim 1, wherein
said attribute setting unit sets a display attribute of contents whose registered date is the current date as a display attribute that is different from a display attribute of contents whose registered date is a preceding date or earlier.

3. The list display data generating apparatus according to claim 1, wherein
said attribute setting unit sets a display attribute of the contents according to a number of days elapsed from the date on which the contents are registered to the current date.

4. The list display data generating apparatus according to claim 1, further comprising
a data transmitting unit externally transmitting the list display data generated by said data generating unit so that an external device displays the list display data.

5. A method generating list display data where contents extracted from registration information are sorted in order of newer arrivals, comprising:
setting a display attribute for contents of a list display target based on a relationship between a date on which the contents are registered and a current date; and
generating list display data of the contents of the list display target by using the set display attribute.

6. A computer-readable storage medium used by a computer for generating list display data where contents extracted from registration information are sorted in order of newer arrivals, on which is recorded a program for causing the computer to execute a process, the process comprising:
setting a display attribute for contents of a list display target based on a relationship between a date on which the contents are registered and a current date; and
generating list display data of the contents of the list display target by using the set display attribute.

7. A program, which is used by a computer for generating list display data where contents extracted from registration information are sorted in order of newer arrivals, for causing the computer to execute a process, the process comprising:
setting a display attribute for contents of a list display target based on a relationship between a date on which the contents are registered and a current date; and
generating list display data of the contents of the list display target by using the set display attribute.

8. The program according to claim 7, wherein
a display attribute of contents whose registered date is the current date is set as a display attribute that is different from a display attribute of contents whose registration date is a preceding day or earlier in setting of the display attribute.

9. The program according to claim 7, wherein
a display attribute of the contents is set according to a number of days elapsed from the date on which the contents are registered to the current date in setting of the display attribute.

10. The program according to claim 7, the process further comprising
externally transmitting the generated list display data so that an external device displays the list display data.
